(19) United States
(12) Patent Application Publication
(10) Pub. No.: US 2025/0088804 A1
(43) Pub. Date: Mar. 13, 2025

(54) ZONE-BASED FUNCTIONALITY AND OPERATION OF AUDIO AMPLIFIERS

(71) Applicant: JUKE AUDIO INC., Manhattan Beach, CA (US)

(72) Inventors: John Bradford Forth, Rio Grande, PR (US); Yutong GU, Los Angeles, CA (US); Bradford Colton Forth, Manhattan Beach, CA (US); Jerry Woods, PITTSBURGH, PA (US)

(21) Appl. No.: 18/829,150

(22) Filed: Sep. 9, 2024

Related U.S. Application Data
(60) Provisional application No. 63/537,159, filed on Sep. 7, 2023.

(51) Int. Cl. H04R 5/04; H04R 27/00

(52) U.S. Cl. CPC H04R 5/04; H04R 27/00; H04R 2227/005; H04R 2420/01

(57) ABSTRACT

According to an aspect of an embodiment, a method may include receiving, at an embedded computing device of a multi-zone audio amplifier system, audio inputs from audio sources. The method may further include mapping the audio inputs to an zone for the audio inputs to be available for the zone, in which the zone represents a location having a speaker configured for playback of sound. A particular audio input may be selected from the audio inputs for transmission to the zone, where such selection may be based on a priority policy. The embedded computing device may transmit the particular audio input to the zone using an amplifier associated with the zone. The method may further include causing the speaker to play the particular audio input.

### CROSS-REFERENCE TO RELATED APPLICATIONS

This patent application claims priority to U.S. Provisional Application No. 63/537,159 filed Sep. 7, 2023, which is incorporated herein by reference in its entirety.

### FIELD

The embodiments discussed in the present disclosure are related to multi-zone audio amplifiers.

### BACKGROUND

A building or home may include multiple zones or rooms that include separate audio output devices such as speakers. An audio system may be used to output different audio inputs at the different audio output devices. The audio system may include devices that receive the audio inputs and provide amplification to drive the audio output devices. As a number of the zones increase, multiple amplifiers or devices that provide amplification may be used to provide amplification to the audio output devices.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include receiving, at an embedded computing device of a multi-zone audio amplifier system, multiple audio inputs from multiple audio sources. The method may further include mapping the audio inputs to a zone for the audio inputs to be available to the zone. The zone may represent a location that includes an audio output device (e.g., a speaker or speakers) configured for playback of sound. A particular audio input may be selected from the audio inputs for transmission to the zone. The embedded computing device may transmit the particular audio input to the zone using an amplifier associated with the zone. The method may further include causing the audio output device to play the particular audio input.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a block diagram of an example environment that includes a multi-zone audio amplifier system to route audio inputs to multiple audio zones;

FIG. 2 illustrates a block diagram of an example of the multi-zone audio amplifier system of FIG. 1 receiving and routing multiple audio inputs;

FIG. 3 illustrates a flow chart of an example method of routing different audio inputs to zones; and

FIG. 4 illustrates a block diagram of an example computing system that may be used with the multi-zone audio amplifier;

all in accordance with one or more embodiments of the present disclosure.

### DESCRIPTION OF EMBODIMENTS

A multi-zone audio system may be used to simultaneously provide various audio output to different zones (e.g., areas) of a building or home. The multi-zone audio system may permit a single instance of audio content to be provided to multiple zones and/or permit different audio outputs to be provided separately to multiple zones at a same time.

Systems exist today that provide audio outputs to numerous zones in buildings or homes. However, these systems consist of devices that receive audio input from a variety of audio sources and provide amplification of the audio outputs to drive audio output devices. For systems in which the audio output devices are wired to a central location, the systems are complex to install and require the connection and/or configuration of a variety of components. Additionally, these wired systems may consume significant amounts of power and generate a lot of heat. These systems typically use analog signal processing between the audio sources and the audio output devices to select audio sources and relative volume levels for each of the zones. Some systems use wireless speakers or distributed amplifiers, which require their own power supplies, enclosures, signal processing and network interfaces.

According to one or more embodiments of the present disclosure, a multi-zone audio amplifier may receive multiple audio inputs and route the audio inputs to multiple zones, each of the zones include an audio output device, such as a speaker. The multi-zone audio amplifier may receive and process multiple audio inputs and provide the audio inputs to an amplifier such that the audio inputs may be provided to the speakers at an amplified level. As described in detail in the present disclosure, the multi-zone audio amplifier may provide the audio inputs to multiple amplifiers using a single data bus. Such implementations allow the multi-zone audio amplifier to be cost-effective and to perform central management of the audio outputs.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

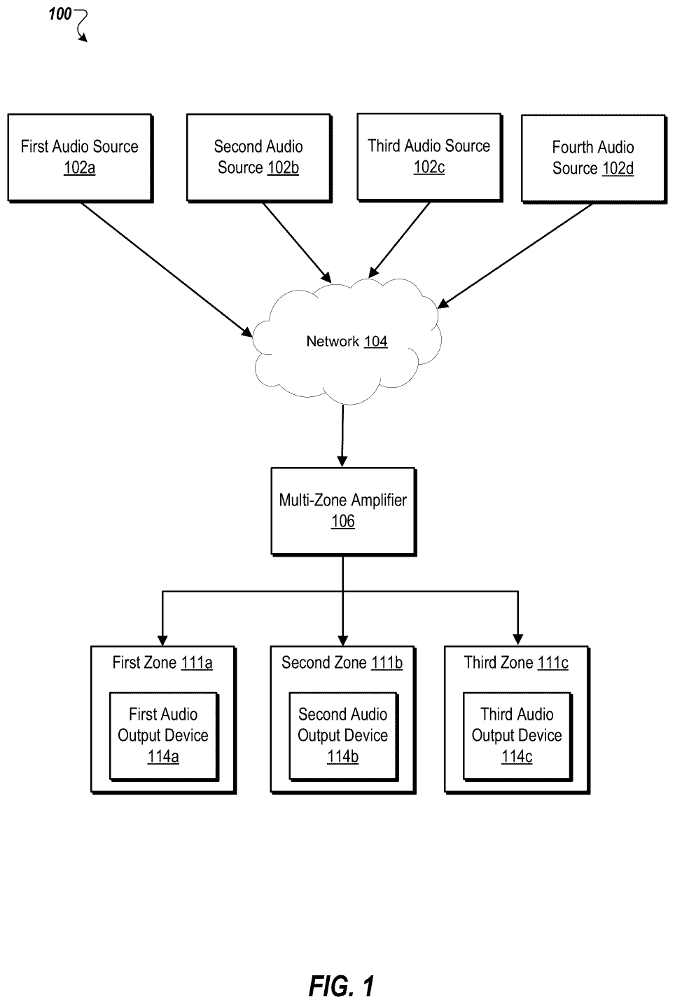

FIG. 1 illustrates an example environment 100 that includes a multi-zone audio amplifier system 106 (“audio amplifier 106”) to route audio inputs to multiple audio zones 111a-c, in accordance with one or more embodiments of the present disclosure. The audio amplifier 106 may receive the audio inputs from multiple audio sources. For example, the audio amplifier 106 may receive the audio inputs from a first audio source 102a, a second audio source 102b, a third audio source 102c, or a fourth audio source 102d (collectively referred to as “audio sources 102”).

The audio sources 102 may include devices that are connected to the audio amplifier 106 via a network 104. For example, the audio sources 102 may include tablets, computers, smart phones, or any other appropriate wired device or wireless device. Although four audio sources 102 are illustrated, any number of audio sources or devices may be used in association with the audio amplifier 106. For example, more or fewer audio sources 102 may be used in association with the audio amplifier 106.

The network 104 may include any suitable type of network such as a local area network (LAN), a wide area network (WAN), a metropolitan area network (MAN), a personal area network (PAN), a campus area network (CAN), a storage area network (SAN), a wireless local area network (WLAN), a cellular network, a satellite network, or any other network which may receive the audio inputs from the audio sources 102 and provide the audio inputs to the audio amplifier 106. In some embodiments, the network 104 may include a Bluetooth network, Wi-Fi, and Ethernet, although other less common connection methods may also be used.

In some embodiments, the audio inputs may correspond to audio data files representative of songs stored in a digital format, audio recordings created or stored by the audio sources 102, among others. Additionally or alternatively, the audio inputs may represent any audio streaming at the audio sources 102, such as YouTube videos and other multimedia contents from the Internet. The audio sources 102 may receive the audio inputs via online sources or platforms such as Apple Music, Spotify, or any other audio stream providing services or applications that may be operating on the audio sources 102. The audio sources 102 may provide the audio inputs to the audio amplifier 106 via the network 104.

The audio amplifier 106 may route the audio inputs to the different zones 111a-c. For example, the audio amplifier 106 may route the audio inputs to a first zone 111a, a second zone 111b, or a third zone 111c (collectively referred to as “zones 111”). Although three zones 111 are illustrated, the audio amplifier 106 may be associated with any suitable number of zones. In the present disclosure, the zones 111 may include physical locations, such as different rooms in a building or a home, different buildings, or any other appropriate physical location. Each of the zones 111 may include audio output devices 114a-c. For example, the first zone 111a may include a first audio output device 114a, the second zone 111b may include a second audio output device 114b, and the third zone 111c may include a third audio output device 114c. Examples of the audio output devices 114a-c include speakers, or any appropriate device configured to play sounds based on the audio inputs. In some embodiments, each audio output device of the audio output devices 114 may include multiple audio output devices. For example, the first audio output device 114a may include a left audio output device corresponding to a left channel of the first zone 111a and a right audio output device corresponding to a right channel of the first zone 111a.

The audio amplifier 106 may route the audio inputs from the audio sources 102 to the zones 111 in various manners. For example, the audio amplifier 106 may route the audio inputs so that each of the zones 111 receives a different audio input. In another example, the audio amplifier 106 may route the audio inputs so that at least two of the zones 111 receive the same audio input.

Modifications, additions, or omissions may be made to the environment 100 without departing from the scope of the present disclosure. For example, in some embodiments, the environment 100 may include any number of other components that may not be explicitly illustrated or described.

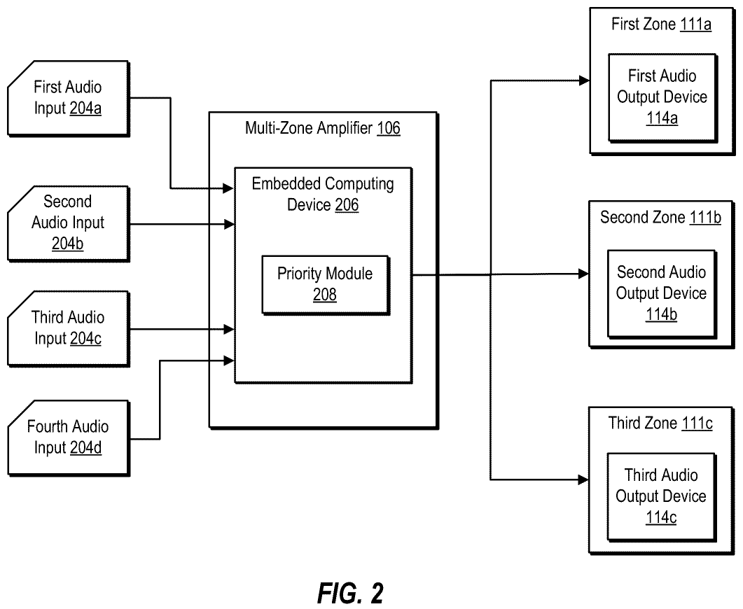

FIG. 2 illustrates a block diagram of an example of the audio amplifier 106 of FIG. 1 receiving and routing multiple audio inputs 204a-d (collectively “audio inputs 204”), in accordance with one or more embodiments of the present disclosure.

In some embodiments, the audio amplifier 106 may include an embedded computing device 206 configured to receive the audio inputs 204 from multiple audio sources. For example, the embedded computing device 206 may receive a first audio input 204a from the first audio source 102a of FIG. 1, a second audio input 204b from the second audio source 102b of FIG. 1, a third audio input 204c from the third audio source 102c of FIG. 1, and a fourth audio input 204d from the fourth audio source 102d of FIG. 1.

In some embodiments, the audio inputs 204 may include different types. For example, the audio inputs may include zone-based audio input types or general audio input types. The zone-based audio inputs may correspond to a particular zone. For instance, the zone-based audio inputs may correspond to a particular zone of the zones 111. For example, the first audio input 204a may correspond to the first zone 111a. In such instances, the zone-based audio inputs may be available only to the corresponding zone.

In some embodiments, the zone-based audio inputs may be configured to automatically map to the corresponding particular zone. In some embodiments, the zone-based audio inputs may broadcast the names of the corresponding audio sources as a name of the particular zone. In some embodiments, the zone-based audio inputs may include Airplay 2 or Spotify Connect. In some instances, the first audio input 204a may correspond to the Airplay 2 for the particular zone. For example, the name “Airplay 2” may be broadcasted as the name of the particular zone. Alternatively, the name may be broadcast as the name of the location of the zone (e.g. kitchen, living room, etc.). In some embodiments, the zone-based audio inputs may include other wireless or wired audio inputs such as a DLNA input or a Radio Corporation of America (RCA) input.

The general audio inputs may correspond to multiple instances of the zones 111. For example, the general audio inputs may be available to any of the zones 111. For example, the second audio input 204b may be a general audio input and available to any of zones 111. In some embodiments, the general audio inputs may include one or more of the following input types: Airplay2, Spotify, RCA, DLNA, optical, Chromecast, and Bluetooth, among others.

In some embodiments, the audio inputs 204a-d may be mapped to particular zones 111. For example, the first audio input 204a, the second audio input 204b, the third audio input 204c, or the fourth audio input 204d may all be mapped to the first zone 111a. As another example, only the second audio input 204b may be mapped to the third zone 111c. The mapping of the audio inputs 204 to the zones 111 may refer to associating the audio inputs 204 to the particular instances of the zones 111 such that the audio inputs 204 are available to the particular zones 111. For example, in instances in which the first audio input 204a includes an Airplay 2 audio input that is mapped to the first zone 111a, the first zone 111a may access the first audio input 204a, which is generated by the Airplay 2.

In instances in which multiple instances of the audio inputs 204 are mapped to the same zone of the zones 111, the embedded computing device 206 may select a particular instance of the audio inputs 204 for transmission to the corresponding zone 111. For example, although multiple instances of the audio inputs 204 may be mapped to the second zone 111b, the second zone 111b may only play, via the second audio output device 114b, one audio input 204 at a given time. Accordingly, in instances in which multiple instances of the audio inputs 204 are mapped to the same zone 111, the embedded computing device 206 may select particular instances of the audio inputs 204 to be transmitted and audibly played at the particular zone 111.

In some embodiments, the embedded computing device 206 may select the particular instances of the audio inputs 204 based on priorities assigned to the audio inputs 204. In these and other embodiments, the embedded computing device 206 may include a priority module 208 configured to determine and assign the priorities to the audio inputs 204.

The priority module 208 may include code and routines configured to enable a computing device to perform one or more operations with respect to prioritizing the audio inputs 204. Additionally or alternatively, the priority module 208 may be implemented using hardware including a processor, a microprocessor (e.g., to perform or control performance of one or more operations), a field-programmable gate array (FPGA), or an application-specific integrated circuit (ASIC). In some other instances, the priority module 208 may be implemented using a combination of hardware and software. In the present disclosure, operations described as being performed by the priority module 208 may include operations that the priority module 208 may direct a corresponding system to perform.

In some embodiments, the priority module 208 may determine the priorities based on a priority policy. The priority policy may include different rules that that indicate the priorities. For example, the priority policy may include rules that are based on time stamps associated with the different audio inputs 204. Additionally or alternatively, the priority module 208 may determine priorities based on times that different instances of the audio inputs 204 were mapped and began actively streaming to the zones 111. The audio inputs 204 may be considered actively streaming in instances in which the audio sources (e.g., audio sources 102 of FIG. 1) actively transmit the corresponding instances of the audio inputs 204 to the embedded computing device 206. When the audio sources stop transmitting the corresponding instances of the audio inputs 204, the corresponding instances of the audio inputs 204 may not be considered actively streaming. In some embodiments, the audio inputs 204 may be considered streaming in instances in which the audio inputs 204 is equal to or exceeds an active threshold. For example, an audio value may be derived from the audio data associated with the audio inputs 204. In some embodiments, the audio value may be derived by performing a running average on absolute value of the audio data. In other embodiments, a root mean squared calculation of the audio data may be used to determine the audio value.

In some embodiments, an instance of the audio inputs 204 that is first to be both mapped and begin actively streaming may be given higher priority. For example, the second audio input 204b may be mapped to the first zone 111a prior to the third audio input 204c being mapped to the first zone 111a, but the third audio input 204c may begin actively streaming before the second audio input 204b begins actively streaming. In this example, the third audio input 204c may be given higher priority than the second audio input 204b.

In some embodiments, an instance of the audio inputs 204 that is last to be or more recently mapped and begin actively streaming may be given higher priority. In these and other embodiments, as an instance of the audio inputs 204 begins actively streaming to a particular zone of the zones 111 subsequent to other instances of the audio inputs 204 streaming to the particular zone of the zones 111, the subsequent instance of the audio inputs 204 may be given priority for the particular zone of the zones 111.

In some embodiments, the priority module 208 may determine the priorities of the audio inputs 204 based on the types of the audio inputs 204. For example, in some embodiments, the zone-based audio inputs may be prioritized over the general audio inputs. As another example, in some embodiments, the audio inputs 204 received via a wired connection may be prioritized over the audio inputs 204 that are received via a wireless connection.

In some embodiments, the priority module 208 may implement any other suitable priority policy. In some embodiments, the priority policy may be specified by a user. For example, the priority module 208 may receive, via a user interface, user input specifying the priority policy.

In some embodiments, the priority of the audio inputs 204 may be recorded or stored in a memory of the audio amplifier 106. For example, the priority module 208 may assign a first priority to the first audio input 204a, a second priority to the second audio input 204b, a third priority to the third audio input 204c, and a fourth priority to the fourth audio input 204d for the first zone 111a. The embedded computing device 206 may transmit the first audio input 204a, based on the assigned priorities, to an amplifier associated with the first zone 111a such that the first audio input 204a may be played in the first zone 111a prior to the second audio input 204b and the third audio input 204c.

In these and other embodiments, the priority of the audio inputs 204 may be stored such that in response to one or more instances of the audio inputs 204 disconnecting, other instances of the audio inputs 204 may be selected as a replacement audio input. For example, the embedded computing device 206 may detect that the first audio input 204a is disconnected due to the corresponding audio source (e.g., the first audio source 102a of FIG. 1) no longer working (e.g., the first audio source 102a stops streaming audio data), a connection failure, or any other reasons and the embedded computing device 206 may select a replacement instance of the audio inputs 204, if available. For example, the embedded computing device 206 may determine that the second audio input 204b with the second priority is still actively streaming to the first zone 111a and the embedded computing device 206 may transmit the second audio input 204b to the first zone 111a.

In some embodiments, different instances of the zones 111 may be associated with different priority policies. For example, the first zone 111a and the second zone 111b may be associated with different priority policies. For example, the priority module 208 may assign priorities to the audio inputs 204 for the first zone 111a based on a first-in-first-out basis (e.g., the first audio input to map and actively stream is given higher priority), while the priority of the audio inputs 204 for the second zone 111b may be based on last-in-first-out (e.g., the latest audio input to map and actively stream is given higher priority).

In some instances, if the priority module 208 assigns priority of the audio inputs 204 based on non-time based priority policies, two or more of the audio inputs 204 may be assigned a same priority level. For example, the priority policy may define assigning the priority based on the types of the audio inputs 204, and two or more of the audio inputs 204 may be of the same types. In such instances, an audio input of the two or more audio inputs may be assigned a revised priority. In some embodiments, the revised priority may be determined based on a first timestamp indicating when the audio input of the two audio inputs was mapped to the corresponding zone of the zones 111 and a second time stamp indicating when the audio input of the two audio inputs was transmitted to the corresponding zone of the zones 111. For example, the two or more audio inputs may be prioritized based on first-in-first-out or last-in-first-out basis.

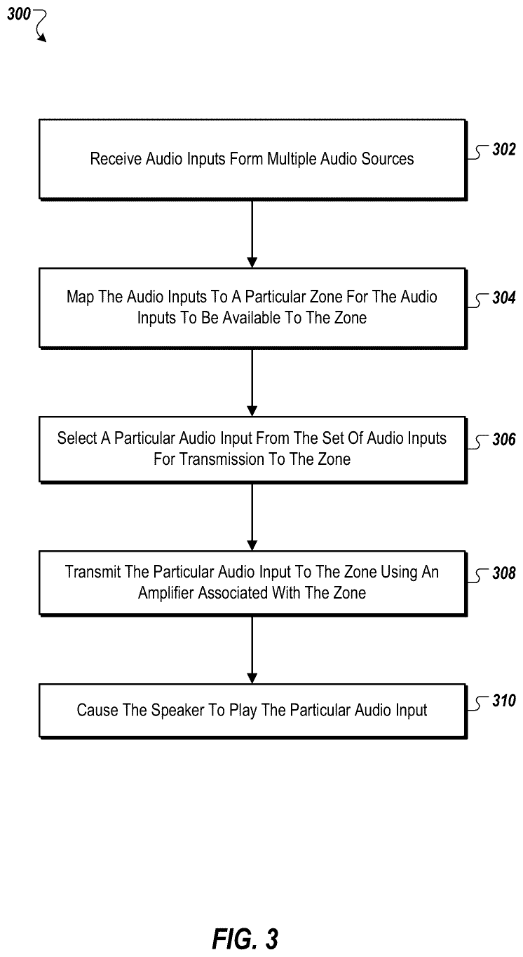

FIG. 3 illustrates a flow chart of an example method 300 of routing audio inputs to zones, arranged in accordance with at least one embodiment of the present disclosure. One or more operations of the method 300 may be implemented by any suitable system such as the audio amplifier 106 or embedded computing device 206 of FIG. 1 or 2. Although illustrated as discrete steps, various steps of the method 300 may be divided into additional steps, combined into fewer steps, or eliminated, depending on the desired implementation. Additionally, the order of performance of the different steps may vary depending on the desired implementation. In some embodiments, the method 300 may include blocks 302, 304, 306, 308, or 310.

At block 302, audio inputs may be received from multiple audio sources. In some embodiments, an embedded computing device may receive the audio inputs. The embedded computing device may correspond to the embedded computing device 206 of FIG. 2 and the audio sources may correspond to the audio sources 102 of FIG. 1. In some embodiments, the embedded computing device may be associated with multiple zones (e.g., the zones 111 of FIGS. 1 and 2).

In some embodiments, the audio inputs may include zone-based audio inputs that correspond to specific instances of the zones and/or general audio inputs corresponding to audio inputs that are available to any of the zones. The zone-based audio inputs may be received at the embedded computing device for a particular zone of the zones, limiting the zone-based audio inputs to being associated with the particular zone. The general audio inputs may be mapped to the multi-zone audio amplifier and/or associated with multiple zones.

At block 304, the audio inputs may be mapped to a particular zone, such that the audio inputs are available to the zone. For example, the zone may have access to the audio inputs to play corresponding sounds via a speaker associated with the zone. At block 306, a particular audio input from the audio inputs may be selected for transmission to the zone. In some embodiments, the particular audio input may be selected from the audio inputs based on a priority policy. The priority policy may include rules in determining priorities between multiple audio inputs mapped to a same zone.

At block 308, the particular audio input may be transmitted to the zone using an amplifier associated with the zone. At block 310, the speaker may be caused to play the particular audio input.

Modifications, additions, or omissions may be made to the method 300 without departing from the scope of the present disclosure. For example, one skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

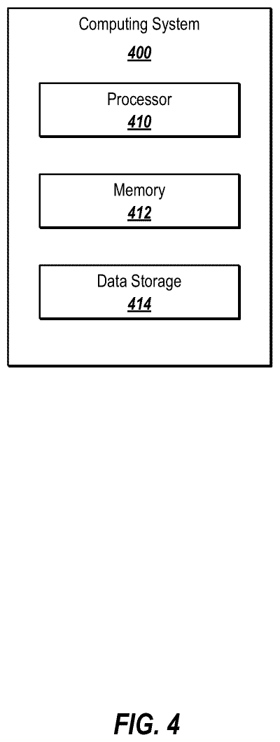

FIG. 4 illustrates a block diagram of an example computing system 400 that may be used with respect a multi-zone audio amplifier, according to at least one embodiment of the present disclosure. For example, the computing system 400 may correspond to the embedded computing device of the multi-zone audio amplifier, such as the embedded computing device 206 of FIG. 2.

The computing system 400 may include a processor 410, a memory 412, and a data storage 414. The processor 410, the memory 412, and the data storage 414 may be communicatively coupled.

In general, the processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 4, the processor 410 may include any number of processors configured to, individually or collectively, perform or direct performance of any number of operations described in the present disclosure. Additionally, one or more of the processors may be present on one or more different electronic devices, such as different servers.

In some embodiments, the processor 410 may be configured to interpret and/or execute program instructions and/or process data stored in the memory 412, the data storage 414, or the memory 412 and the data storage 414. In some embodiments, the processor 410 may fetch program instructions from the data storage 414 and load the program instructions in the memory 412. After the program instructions are loaded into memory 412, the processor 410 may execute the program instructions.

The memory 412 and the data storage 414 may include computer-readable storage media for carrying or having computer-executable instructions or data structures stored thereon. Such computer-readable storage media may include any available media that may be accessed by a general-purpose or special-purpose computer, such as the processor 410. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

Modifications, additions, or omissions may be made to the computing system 400 without departing from the scope of the present disclosure. For example, in some embodiments, the computing system 400 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
receiving, at an embedded computing device of a multi-zone audio amplifier, a plurality of audio inputs from a plurality of audio sources;
mapping the plurality of audio inputs to a zone for the plurality of audio inputs to be available for the zone, wherein the zone represents a location having a speaker configured for playback of sound;
selecting a particular audio input from the plurality of audio inputs for transmission to the zone;
transmitting the particular audio input to the zone using an amplifier associated with the zone; and
causing the speaker to play the particular audio input.

2. The method of claim 1, wherein the plurality of audio inputs includes zone-based audio inputs specifically for the zone and general audio inputs corresponding to audio inputs that are available to any zones including the zone.

3. The method of claim 2, wherein the zone-based audio inputs are limited to being associated with the zone.

4. The method of claim 2, wherein the general audio inputs are mapped to the multi-zone audio amplifier to be available for each of the zones associated with the multi-zone audio amplifier.

5. The method of claim 2, wherein the zone-based audio inputs are prioritized over the general audio inputs.

6. The method of claim 1, wherein the particular audio input is selected based on a priority policy.

7. The method of claim 6, wherein the priority policy prioritizes audio inputs of the plurality of audio inputs based on types of the audio inputs.

8. The method of claim 7, wherein individual audio inputs of the plurality of audio inputs that are received via a wired connection are prioritized over individual audio inputs of the plurality of audio inputs that are received via a wireless connection.

9. The method of claim 6, wherein the priority policy is received from a user.

10. The method of claim 6, further comprising:
mapping an audio input of the plurality of audio inputs to a second zone of a plurality of zones, wherein the plurality of zones comprises a first zone; and
selecting a second particular audio input from the audio input for transmission to the second zone, the second particular audio input selected based on the priority policy, wherein the priority policy indicates a difference in priority for the first zone and the second zone.

11. The method of claim 1, further comprising:
assigning priorities to each audio input of the plurality of audio inputs based on a priority policy with respect to the zone, wherein the priorities are stored in a memory.

12. The method of claim 11, further comprising:
detecting disconnection of the particular audio input, wherein a particular audio source associated with the audio input stops transmitting the audio input;
selecting a replacement audio input from the plurality of audio inputs based on the priorities; and
transmitting the replacement audio input to the zone using the amplifier associated with the zone.

13. The method of claim 11, further comprising:
determining two audio inputs of the plurality of audio inputs that are assigned a same priority level; and
assigning a revised priority to an audio input of the two audio inputs based on a first timestamp indicating when the audio input of the two audio inputs was mapped to the zone and a second timestamp indicating when the audio input of the two audio inputs began actively streaming.

14. The method of claim 13, wherein the two audio inputs are considered as actively streaming responsive to audio data corresponding to the two audio inputs being equal to or exceeding a active threshold.

15. The method of claim 14, wherein:
the two audio inputs are prioritized based on last-in-first-out basis; and
a more recent audio stream to be mapped and actively streaming is prioritized.

16. The method of claim 14, wherein:
the two audio inputs are prioritized based on first-in-first-out basis; and
a first audio stream to be mapped and actively streaming is prioritized.

17. A system comprising:
an embedded computing device configured to:
receive a plurality of audio inputs from a plurality of audio sources;
map the plurality of audio inputs to a zone for the plurality of audio inputs to be available for the zone, wherein the zone representing a location having a speaker configured for playback of sound;
select a particular audio input from the plurality of audio inputs for transmission to the zone;
transmit the particular audio input to the zone using an amplifier associated with the zone; and
causing the speaker to play the particular audio input; and
a plurality of amplifiers comprising the amplifier, each amplifier of the plurality of amplifiers associated with a respective speaker.

18. The system of claim 17, wherein the embedded computing device is one of a field programmable gate array (FPGA), a digital signal processor (DSP), a microprocessor or a microcontroller.

19. The system of claim 17, wherein the particular audio input is selected based on a priority policy.

20. The system of claim 17, wherein the embedded computing device is further configured to:
assign priorities to each audio input of the plurality of audio inputs based on a priority policy with respect to the zone, wherein the priorities are stored in a memory.
